(19) United States
(12) Patent Application Publication
(10) Pub. No.: US 2004/0251814 A1
(43) Pub. Date: Dec. 16, 2004

(54) Electroluminescent display device

(75) Inventors: Ryuji Nishikawa, Gifu-shi (JP); Kazuyuki Maeda, Nishikasugai-gun (JP)

Correspondence Address: MORRISON & FOERSTER LLP, 1650 TYSONS BOULEVARD, SUITE 300, MCLEAN, VA, 22102, US

(73) Assignee: Sanyo Electric Co., Ltd., Moriguchi-city (JP)

(21) Appl. No.: 10/758,593

(22) Filed: Jan. 16, 2004

(30) Foreign Application Priority Data
Jan. 21, 2003 (JP) 2003-012383

(51) Int. Cl. H05B 33/08; H05B 33/00

(52) U.S. Cl. 313/500; 313/505; 313/503

(57) ABSTRACT

The invention provides an electroluminescent display device using a white organic EL layer and color filter layers where color purity of a panel is properly secured. Film thicknesses or pigment concentrations of R, G, and B color filter layers are adjusted so that transmittances of the R, G, and B color filter layers become 50% or less for light outside a predetermined wavelength range. By narrowing the predetermined wavelength range more, spectral characteristics of each of R, G, and B colors can be improved. Therefore, the color purity of the panel can be secured even when using the white organic EL layer.

### BACKGROUND OF THE INVENTION

1. Field of the Invention

The invention relates to an electroluminescent display device, particularly to an electroluminescent display device having color filter layers.

2. Description of the Related Art

An organic electroluminescent (hereafter, referred to as EL) element is a self-emissive element. An organic EL display device using the organic EL elements is receiving an attention as a new display device substituted for a CRT or an LCD.

FIG. 3 is a schematic cross-sectional view showing a pixel of a full-color organic EL display device of the conventional art. A numeral 200 designates a glass substrate, a numeral 201 designates an organic EL element driving TFT (thin film transistor) formed on the glass substrate 200, and a numeral 202 designates a first planarization insulating film. A numeral 203 designates an anode layer made of ITO (indium tin oxide) which is connected with the TFT 201 and extends over the first planarization insulating film 202, and a numeral 204 designates a second planarization insulating film formed so as to cover end portions of the anode layer 203. A numeral 205 designates R (red), G (green), and B (blue) organic EL layers each formed on the anode layer 203, and a numeral 206 designates a cathode layer formed on the organic EL layers 205.

A glass substrate 207 covers the cathode layer 206. The glass substrate 207 and the glass substrate 200 are attached at their edges to enclose the R, G, and B organic EL layers 205 therein. Here, the R, G, and B organic EL layers 205 are respectively formed by selectively performing vapor-deposition of organic EL materials which emit each of R, G, and B lights by using a metal mask.

On the other hand, as a method of realizing a full-color organic EL display device without the above R, G, and B organic EL layers 205, using color filter layers has been proposed. In this method, a combination of a white organic EL layer and color filter layers has been employed.

The organic EL display device of this type is described in Japanese Patent Application Publication No. Hei 8-321380.

However, when employing the combination of the white organic EL layer and the color filter layers, spectral characteristics of the color filter layers must be designed to accommodate spectral characteristics of the white organic EL layer.

FIG. 4 shows spectral characteristics of a white organic EL layer and a backlight (a fluorescent lamp of three wavelengths) usually used for a liquid crystal display. As obvious from FIG. 4, light of the fluorescent lamp of three wavelengths has an isolated peak in each range of R, G, and B wavelengths, that is, in a B (blue) wavelength range around at 440 nm, a G (green) wavelength range around at 550 nm, and a R (red) wavelength range around at 630 nm.

On the other hand, the white organic EL layer has broad spectral characteristics and high light intensity over the broad wavelength range so that color purities of R, G, and B are hardly obtained. Therefore, it has been difficult to secure color purity of the organic EL panel.

### SUMMARY OF THE INVENTION

An object of the invention is to secure the color purity of the organic EL panel by properly adjusting the spectral characteristics of the color filter layers in consideration of the broad spectral characteristics of the white organic EL layer.

The invention provides an electroluminescent display device that includes a red pixel, a green pixel and a blue pixel, a red filter layer, a green filter layer and a blue filter layer that are provided for the red, green and blue pixels, respectively, an electroluminescent element having a white electroluminescent emissive layer and formed above each of the red, green and blue filter layers, and a thin film transistor driving the electroluminescent element and provided for each of the red, green and blue pixels. The light transmittance of the red filter layer is 50% or lower at 584 nm, the light transmittance of the green filter layer is 50% or lower between 482 nm and 588 nm, and the light transmittance of the blue filter layer is 50% or lower between 407 nm and 516 nm.

### BRIEF DESCRIPTION OF THE DRAWINGS

FIG. 1 is a schematic cross-sectional view of a pixel of an organic EL display device of an embodiment of the invention.

FIG. 2 shows results of simulation of spectral characteristics when a film thickness of a color filter layer is changed in the display device shown in FIG. 1.

FIG. 3 is a schematic cross-sectional view of a pixel of a full-color organic EL display device of the conventional art.

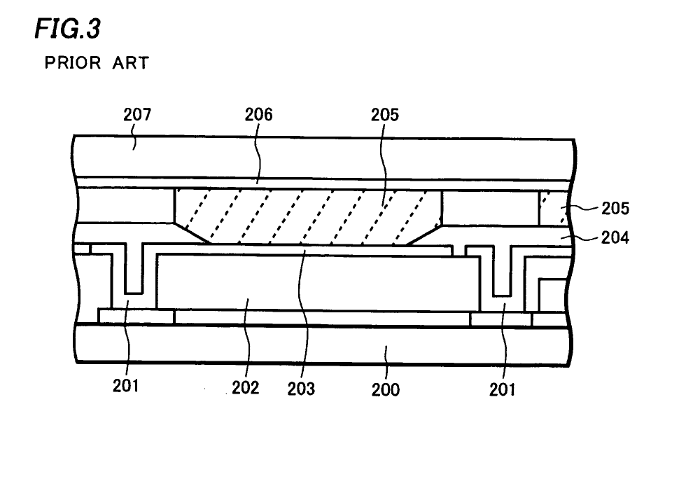

FIG. 4 shows spectral characteristics of a white organic EL layer and a backlight (a fluorescent lamp of three wavelengths) that are used for a conventional liquid crystal display device.

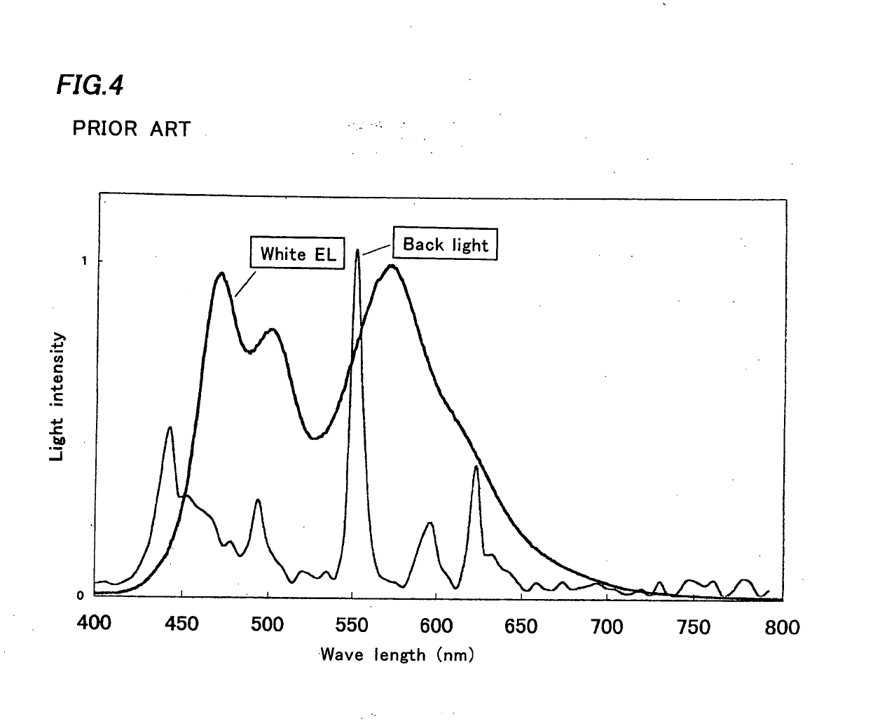

### DETAILED DESCRIPTION OF THE INVENTION

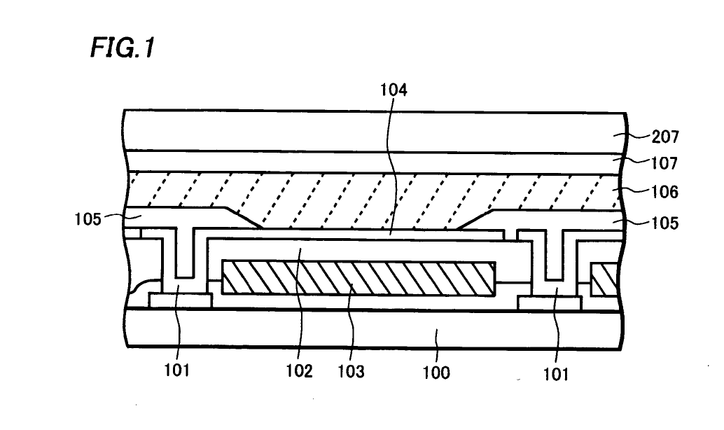

An embodiment of the invention will be described with reference to the drawings in detail. FIG. 1 is a schematic cross-sectional view showing a pixel of an organic EL display device of the embodiment. In an actual organic EL display device, a plurality of the pixels is arranged in a matrix.

A numeral 100 designates a transparent insulating substrate such as a glass substrate, and a numeral 101 designates an organic EL element driving TFT (thin film transistor) formed on the insulating substrate 100 which supplies a drive current to the organic EL element based on display data.

A numeral 102 designates a first planarization insulating film. A numeral 103 designates a color filter layer buried in the first planarization insulating film 102. The color filter layer is provided in each of R (red), G (green), and B (blue) pixels and contains a pigment corresponding to each of R, G, and B colors.

A numeral 104 designates an anode layer made of ITO (indium tin oxide), which is connected with the TFT 101 and extends over the first planarization insulating film 102. A numeral 105 designates a second planarization insulating film formed so as to cover end portions of the anode layer 104.

The second planarization insulating film 105 is formed with an opening except above the end portions of the anode layer 104. A white organic EL layer 106 is formed on the anode layer 104 exposed in the opening, and a cathode layer 107 is formed on the organic EL layer 106. A glass substrate 207 covers the cathode layer 107.

The white organic EL layer 106 is formed not only on the anode layer 104 exposed in the opening but also on the second planarization insulating film 105. This makes it unnecessary to use a vapor deposition mask for forming the white organic EL layers in a position corresponding to R, G, and B colors to isolate them as islands.

When the drive current is supplied from the TFT 101, the organic EL layer 106 emits white light, and the white light is transmitted through the color filter layer 103 to form predetermined spectra. The light is emitted to an outside through the insulating substrate 100.

A feature of the invention is to adjust a film thickness or a pigment concentration of the color filter layer 103 so that the transmittance of the color filter layer 103 of each of R, G, and B colors becomes 50% or less for light outside a predetermined wavelength range. Narrowing the predetermined wavelength range improves the spectral characteristics of each of R, G, and B colors. Therefore, color purity of the panel can be secured even when using the white organic EL layer 106.

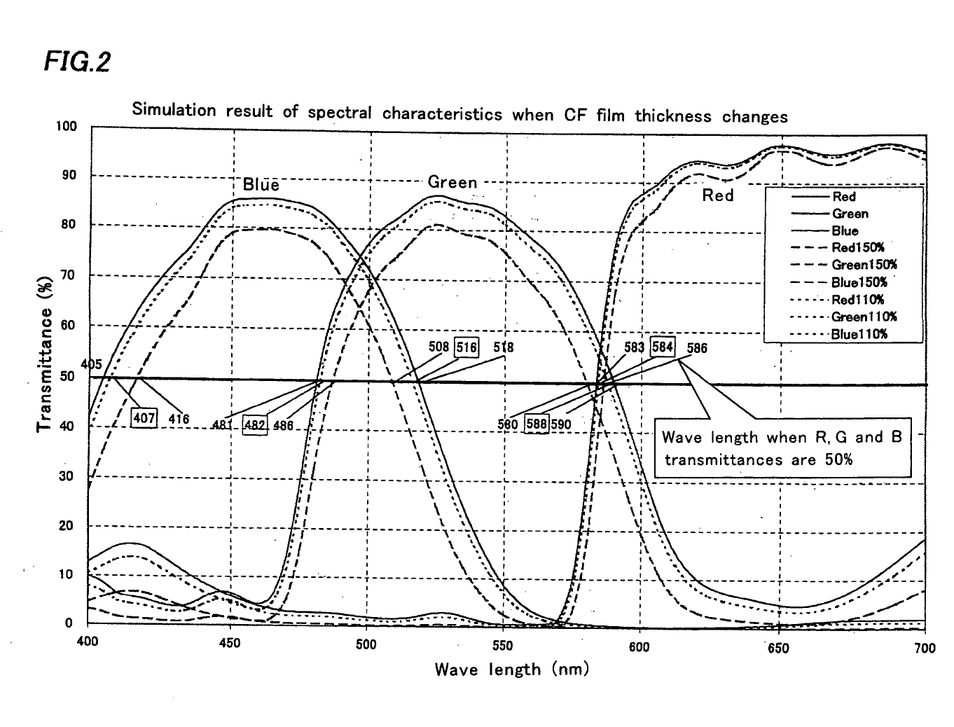

Next, adjusting the spectral characteristics of the color filter layer 103 will be described. FIG. 2 is a graph showing a simulation result of the spectral characteristics when the film thickness of the color filter layer 103 is changed.

In FIG. 2, the solid line shows the spectral characteristics of the original color filter layer 103 of each of R, G, and B colors where the film thickness is set as 100%. The dotted line shows the spectral characteristics of the color filter layer 103 of each of R, G, and B colors where the film thickness is increased by 10% from the original thickness. The broken line shows the spectral characteristics of the color filter layer 103 of each of R, G, and B colors where the film thickness is increased by 50% from the original thickness.

As the film thicknesses of the R, G, and B color filter layers 103 increase, the wavelength ranges of 50% transmission or higher becomes narrower.

That is, when using the original color filter layer 103 where the thickness is set as 100%, the transmittance of the R color filter layer is 50% or less for light having the wavelength of 583 nm or less, the transmittance of the G color filter layer is 50% or less for light having the wavelength of 481 nm or less and 590 nm or more, and the transmittance of the B color filter layer is 50% or less for light having the wavelength of 405 nm or less and 518 nm or more. When using the color filter layer 103 where the film thickness is increased by 10% from the original thickness, the transmittance of the R color filter layer is 50% or less for light having the wavelength of 584 nm or less, the transmittance of the G color filter layer is 50% or less for light having the wavelength of 482 nm or less and 588 nm or more, and the transmittance of the B color filter layer is 50% or less for light having the wavelength of 407 nm or less and 516 nm or more.

When using the color filter layer 103 where the film thickness is increased by 50% from the original thickness, the transmittance of the R color filter layer is 50% or less for light having the wavelength of 586 nm or less, the transmittance of the G color filter layer is 50% or less for light having the wavelength of 486 nm or less and 580 nm or more, and the transmittance of the B color filter layer is 50% or less for light having the wavelength of 416 nm or less and 508 nm or more.

When increasing the film thickness by 10% from the original thickness as described above, the spectral characteristics of R, G, and B colors are each improved, and the color purity of the panel can be secured even when using the white organic EL layer 106. The same effect is obtained when the film thickness is increased by 50%.

Similar spectral characteristics are realized by increasing pigment concentrations, rather than increasing the film thicknesses of the R, G, and B color filter layers 103.

What is claimed is:

1. An electroluminescent display device comprising:
a red pixel, a green pixel and a blue pixel;
a red filter layer, a green filter layer and a blue filter layer that are provided for the red, green and blue pixels, respectively;
an electroluminescent element having a white electroluminescent emissive layer and formed above each of the red, green and blue filter layers; and
a thin film transistor driving the electroluminescent element and provided for each of the red, green and blue pixels,
wherein a thickness or a pigment concentration of each of the red, green and blue filter layers is adjusted so as to narrow a peak width of light passing through a corresponding filter layer so that color purity of the display device is improved.

2. An electroluminescent display device comprising:
a red pixel, a green pixel and a blue pixel;
a red filter layer, a green filter layer and a blue filter layer that are provided for the red, green and blue pixels, respectively;
an electroluminescent element having a white electroluminescent emissive layer and formed above each of the red, green and blue filter layers; and
a thin film transistor driving the electroluminescent element and provided for each of the red, green and blue pixels,
wherein a light transmittance of the red filter layer is 50% or lower at 584 nm, a light transmittance of the green filter layer is 50% or lower between 482 nm and 588 nm, and a light transmittance of the blue filter layer is 50% or lower between 407 nm and 516 nm.
